(19) United States
(12) Patent Application Publication
(10) Pub. No.: US 2017/0344215 A1
(43) Pub. Date: Nov. 30, 2017

(54) INPUT METHOD AND ELECTRONIC DEVICE

(71) Applicant: Lenovo (Beijing) Limited, Beijing (CN)

(72) Inventor: Shuxian Zhang, Beijing (CN)

(21) Appl. No.: 15/609,395

(22) Filed: May 31, 2017

(30) Foreign Application Priority Data
May 31, 2016 (CN) 201610378359.1
May 31, 2016 (CN) 201610382265.1

(51) Int. Cl. G06F 3/0488; G06F 3/0484

(52) U.S. Cl. CPC G06F 3/0488; G06F 3/0484; G06F 2203/04803

(57) ABSTRACT

One embodiment provides a method, including: detecting, at an information handling device, a first touch operation in a first input area and a second touch operation in a second input area, wherein the first touch operation detected in the first input area corresponds to a first function and the touch operation in the second input area corresponds to a second function, the first function being different from the second function; and executing, using a processor, a third function, wherein the third function combines the first function and the second function. Other aspects are described and claimed.

### CLAIM FOR PRIORITY

This application claims priority to Chinese Application Nos. 201610378359.1 and 201610382265.1, both of which were filed on May 31, 2016, which are fully incorporated by reference herein.

### FIELD

The subject matter described herein relates to the field of information, and in particular, to an input method and an electronic device. The subject matter described herein also relates to the technical field of electronic devices, and more particularly, relates to a touch component and an electronic device.

### BACKGROUND

Conventionally, a user usually utilizes physical keys for text input and a touchpad for mouse operation when performing text and mouse inputs while using a notebook computer or an electronic device connected to an external keyboard having a touchpad. The user may implement movement of a mouse by a slide input on the touchpad when the touchpad is utilized for the mouse operation.

### BRIEF SUMMARY

In summary, one aspect provides a method, comprising: detecting, at an information handling device, a first touch operation in a first input area and a second touch operation in a second input area, wherein the first touch operation detected in the first input area corresponds to a first function and the touch operation in the second input area corresponds to a second function, the first function being different from the second function; and executing, using a processor, a third function, wherein the third function combines the first function and the second function.

Another aspect provides a method, comprising: receiving, at a touch component, a touch operation, wherein the touch component comprises at least two touch areas and wherein each touch area of the at least two touch areas is physically distinct from other touch areas of the at least two touch areas; and executing, using a processor, a control instruction associated with the touch operation, wherein the control instruction is dependent on the touch area the touch operation is provided to.

A further aspect provides an electronic device, comprising: a touch component integral to the electronic device, wherein the touch component comprises at least two touch areas; wherein each touch area of the at least two touch areas is physically distinct from other touch areas of the at least two touch areas; and wherein each touch area of the at least two touch areas is associated with a control instruction, wherein the control instruction is different for each touch area of the at least two touch areas.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 is a structural schematic flow diagram illustrating an input method according to an embodiment.

FIG. 2 is a structural schematic diagram showing a touch operation detected by a touch input apparatus according to an embodiment.

FIG. 3 is a structural schematic diagram showing another touch operation detected by a touch input apparatus according to an embodiment.

FIG. 4 is a structural schematic diagram showing another touch operation detected by a touch input apparatus according to an embodiment.

FIG. 5 is a structural schematic diagram of another touch operation detected by a touch input apparatus according to an embodiment.

FIG. 6 is a structural schematic block diagram illustrating an electronic device according to an embodiment.

FIG. 7 is a structural schematic view showing a touch component according to an embodiment.

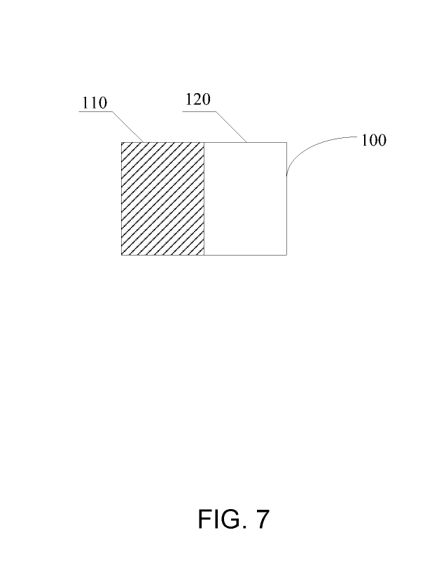

FIG. 8 is a structural schematic view showing a touch component according to an embodiment.

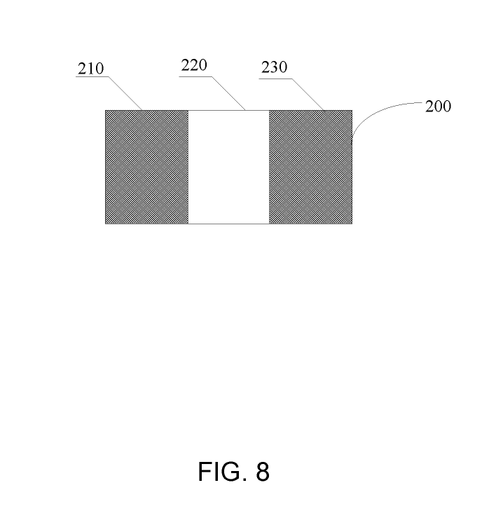

FIG. 9 is a structural schematic view of a touch component according to an embodiment.

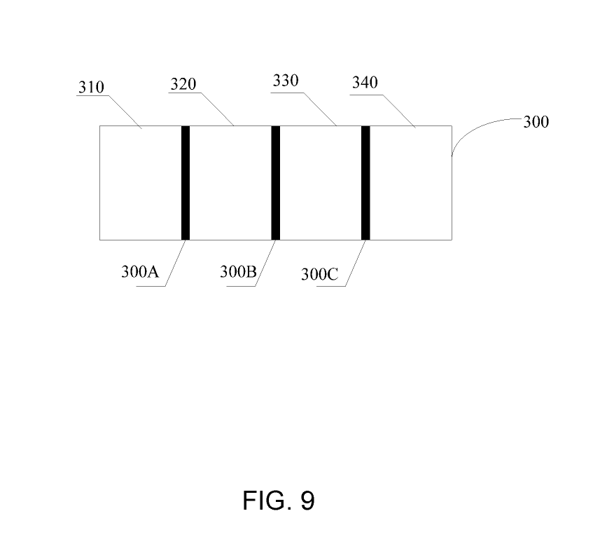

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

### Input Method and Electronic Device

The mouse movement input on the touchpad can implement only a single cursor movement function. If the user desires to execute a function other than the cursor movement, physical keys have to be used. For example, two physical keys are usually disposed below the touchpad, wherein one physical key corresponds to a left mouse button and the other physical key corresponds to a right mouse button. The physical key corresponding to the left mouse button has to be pressed when the user desires to trigger a function of the left mouse button.

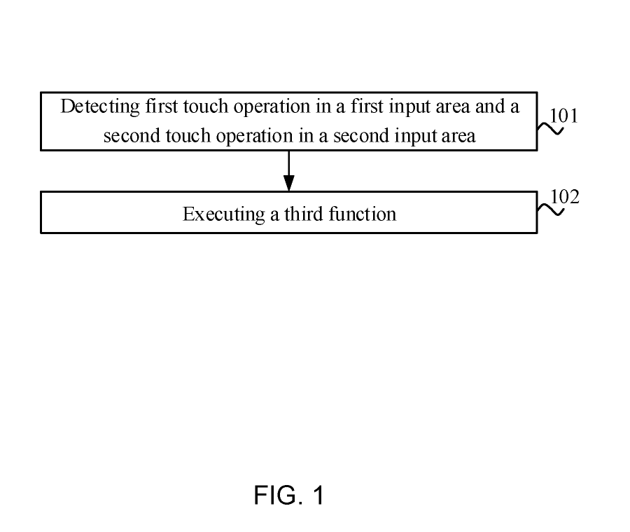

Referring now to FIG. 1, a structural schematic flow diagram of an input method according to an embodiment is provided. The method illustrated in FIG. 1 may be applied to an electronic device having a touch input apparatus. The touch input apparatus comprises a first input area and a second input area.

At 101, a first touch operation in the first input area and a second touch operation in the second input area are detected. The touch operation detected in the first input area corresponds to a first function and the touch operation detected in the second input area corresponds to a second function. The first function being different from the second function. At 102, a third function is executed, wherein the third function combines the first function and the second function.

According to the method illustrated in FIG. 1, respective functions in different input areas may be combined to implement other functions when the touch input apparatus separately detects touch operations in different input areas. Moreover, the touch input apparatus may be one complete touch input pad. Different input areas on the touch input apparatus correspond to different functions. As such, disposition of physical keys having the same functions is not required on the electronic device, so that the number of the physical keys on the electronic device may be reduced.

Optionally, in some embodiments, the detecting a first touch operation in the first input area and a second touch operation in the second input area comprises simultaneously detecting the first touch operation in the first input area and the second touch operation in the second input area. As such, functions corresponding to touch operations in different input areas detected simultaneously may be combined to implement other functions.

Optionally, in some other embodiments, the detecting a first touch operation in the first input area and a second touch operation in the second input area comprises continuously detecting the first touch operation in the first input area and the second touch operation in the second input area, wherein the first touch operation and the second touch operation are continuous slide touch operations on paths. As such, functions corresponding to touch operations in different input areas detected continuously with respect to time may be combined to implement other functions.

The detecting, continuously, the first touch operation in the first input area and the second touch operation in the second input area comprises detecting a first slide touch operation passing through the first input area and the second input area. In other words, the first touch operation in the first input area may be said to be detected when the first slide touch operation passing through the first input area is detected and the second touch operation in the second input area may be said to be detected when the first slide touch operation passing through the second input area is detected. The first touch operation and the second touch operation are continuous with respect to time.

In this situation, the executing a third function may be executing a function corresponding to an area where a start position or an end position of the first slide touch operation is located. Further, the executing a third function may further comprise prohibiting execution of a function corresponding to an area where a non-start position or a non-end position through which the first slide touch operation passes is located.

Optionally, in some embodiments, the method may further comprise: detecting a touch operation having multiple touch points in the first input area, and executing a corresponding function according to the number and movement paths of the multiple touch points.

Optionally, in some embodiments, the first input area may be configured to simulate a mouse movement and the second area may be configured to simulate a mouse function button. In this situation, the first function is moving a cursor if a continuous slide is detected in the first input area. The first function is simulating tap of a left mouse button if a single finger tap is detected in the first input area and the first function is an information drag function if a single finger double click without lift is detected in the first input area. For example, the dragging of texts, icons etc. The second function is simulating trigger of a mouse function button.

Optionally, in some embodiments, the first input area may be configured to simulate the mouse function button and the second area may be configured to simulate the mouse movement. In this situation, the first function is simulating trigger of the mouse function button. The second function is moving a cursor if a continuous slide is detected in the second input area. The second function is simulating tap of a left mouse button if a single finger tap is detected in the second input area and the second function is an information drag function if a single finger double click without lift is detected in the second input area. For example, the dragging of texts, icons etc.

The mouse function button may be the left mouse button or the right mouse button.

The touch input apparatus is a device that supports multi-touch input. For example, the touch input apparatus may support a touch input comprising a maximum of three touch points. As such, functions corresponding to areas where various touch points are may be implemented simultaneously. Alternatively, functions corresponding to areas where various touch points are may be combined to implement other functions, or different functions may be implemented according to different numbers of touch points and/or different position changes of touch points.

It may be understood that the first input area and the second input area are printed on the touch input apparatus by using a screen printing technology etc. Therefore, a user may discriminate ranges of the first input area and the second input area.

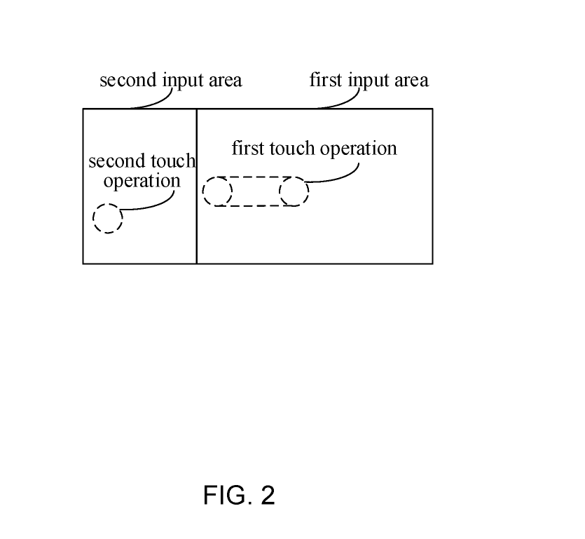

Referring now to FIG. 2, a structural schematic diagram of a touch operation detected by a touch input apparatus of the electronic device according to an embodiment is provided. In FIG. 2, the first input area is configured to simulate the mouse movement, the second input area is configured to simulate the mouse function button, and the mouse function button is the left mouse button.

As shown in FIG. 2, the first touch operation is one slide touch operation and the second touch operation is one static touch operation. In this situation, the first function is moving a cursor and the second function is simulating trigger of the left mouse button. The first touch operation and the second touch operation are detected simultaneously. For example, the user may execute the following operation: the user touches the first input area using one finger and slides in the second touch area using another finger. In this situation, the first touch operation in the first input area and the second touch operation in the second input area may be detected simultaneously.

The executing a third function may involve performing an information selection according to a cursor movement path. The information selection may be a text selection, an icon selection, a file selection etc. Certainly, the third function may also be another default function or a function configured by the user according to requirements. For example, the third function may also be dragging and dropping an icon, scrolling a screen, dragging an icon, dragging text etc.

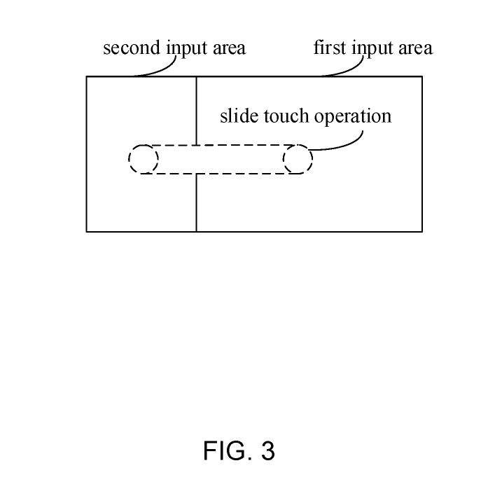

Referring now to FIG. 3, a structural schematic diagram of another touch operation detected by the touch input apparatus of the electronic device according to an embodiment is provided. In FIG. 3, the first input area is configured to simulate the mouse movement and the second input area is configured to simulate the mouse function button.

The slide touch operation as shown in FIG. 3 may be sliding from the first input area to the second input area. For example, the user touches the first input area by using one finger, maintaining a touch state and sliding from the first input area to the second input area, followed by lifting the finger. In this situation, detection of one slide touch operation may be identified according to a position change of the touch point. The slide touch operation passes successively through the first input area and the second input area. The start position of the slide touch operation is located in the first input area and the end position of the slide touch operation is located in the second input area.

Optionally, in some embodiments, the executing a third function may comprise moving the cursor when detecting a slide of the slide touch operation in the first input area and stopping movement of the cursor when detecting a movement of the slide touch operation to the second input area. In other words, only a function for an area where the start position of the slide touch operation is located is executed. When the slide touch operation leaves an area where an initial position is located, execution of a function for the area where the initial position is located is stopped and a function corresponding to an area where a non-initial position is located is not executed.

Optionally, in some other embodiments, the executing a third function may comprise moving the cursor when detecting a slide of the slide touch operation in the first input area and continuously moving the cursor when detecting a movement of the slide touch operation to the second input area. In other words, the function corresponding to the area where the initial position is located is executed regardless of the area in which the slide touch operation moves.

Optionally, in some other embodiments, the executing a third function may comprise not moving the cursor when detecting a slide of the slide touch operation in the first input area and simulating trigger of the mouse function button when detecting a movement of the slide touch operation to the second input area. In other words, only the function for the area where the end position of the slide touch operation is located is executed and the function corresponding to the area where the initial position is located is not executed.

The slide touch operation as shown in FIG. 3 may be sliding from the second input area to the first input area. For example, the user touches the second input area by using one finger, sliding from the second input area to the first input area, followed by lifting the finger. In this situation, detection of one slide touch operation may be identified according to a position change of the touch point. The slide touch operation passes successively through the second input area and the first input area. The start position of the slide touch operation is located in the second input area and the end position of the slide touch operation is located in the first input area.

Optionally, in some other embodiments, the executing a third function may comprise simulating trigger of the mouse function button when detecting a slide of the slide touch operation in the second input area and not simulating trigger of the mouse function button when detecting a movement of the first slide touch operation to the first input area. In other words, only a function for an area where the start position of the slide touch operation is located is executed. When the slide touch operation leaves an area where an initial position is located, execution of a function for the area where the initial position is located is stopped and a function corresponding to an area where a non-initial position is located is not executed.

Optionally, in some other embodiments, the executing a third function may comprise simulating trigger of the mouse function button when detecting a slide of the slide touch operation in the second input area and continuously simulating trigger of the mouse function button when detecting a movement of the slide touch operation to the first input area. In other words, the function corresponding to the area where the initial position is located is executed regardless of the area in which the slide touch operation moves.

Optionally, in some other embodiments, the executing a third function may comprise not simulating trigger of the mouse function button when detecting a slide of the slide touch operation in the second input area and moving the cursor when detecting a movement of the slide touch operation to the first input area. In other words, only the function for the area where the end position of the slide touch operation is located is executed and the function corresponding to the area where the initial position is located is not executed.

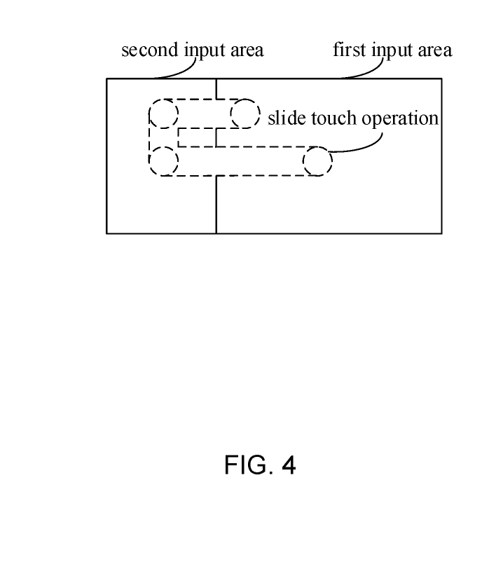

Referring now to FIG. 4, a structural schematic diagram of another touch operation detected by the touch input apparatus of the electronic device according to an embodiment is provided.

The slide touch operation shown in FIG. 4 passes successively through the first input area, the second input area, and back through the first input area. For example, the user touches the first input area by using one finger, maintaining a touch state and sliding from the first input area to the second input area, maintaining the touch state continuously and sliding from the second input area to the first input area, followed by lifting the finger. In this situation, detection of one slide touch operation may be identified according to a position change of the touch point. The slide touch operation passes successively through the first input area, the second input area, and back through the first input area. The start position of the slide touch operation is located in the first input area and the end position of the slide touch operation is also located in the first input area.

In some embodiments, the first input area shown in FIG. 4 may be configured to simulate the mouse movement and the second input area may be configured to simulate the mouse function button. In this situation, in some embodiments, the executing the third function may comprise moving the cursor when detecting a slide of the slide touch operation in the first input area and stopping movement of the cursor when detecting a slide of the slide touch operation to the second input area. In other words, the cursor stops moving if the slide of the slide touch operation from the first input area to the second input area is detected and the cursor moves if the slide of the slide touch operation in the first input area or the slide of the slide touch operation from the second input area to the first input area is detected. In some other embodiments, the executing the third function may comprise moving the cursor when detecting a slide of the slide touch operation in the first input area and continuously moving the cursor when detecting a slide of the slide touch operation to the second input area. In other words, the function corresponding to the area where the start position is located is always executed, i.e., the cursor moves, regardless of the detected area in which the slide touch operation is located.

In some other embodiments, the first input area shown in FIG. 4 may be configured to simulate the mouse function button and the second input area may be configured to simulate the mouse movement. In this situation, in some other embodiments, the executing the third function may comprise simulating trigger of the mouse function button when detecting a slide of the slide touch operation in the first input area; and not simulating trigger of the mouse function button when detecting a slide of the slide touch operation to the second input area. In other words, the trigger of the mouse function button is stopped if the slide of the slide touch operation from the first input area to the second input area is detected and the trigger of the mouse function button is simulated if the slide of the slide touch operation in the first input area or the slide of the slide touch operation from the second input area to the first input area is detected. In some other embodiments, the executing the third function may comprise: simulating trigger of the mouse function button when detecting a slide of the slide touch operation in the first input area and continuously simulating trigger of the mouse function button when detecting a slide of the slide touch operation to the second input area. In other words, the function corresponding to the area where the start position is located is always executed, i.e., the mouse function button is triggered, regardless of the detected area in which the slide touch operation is located.

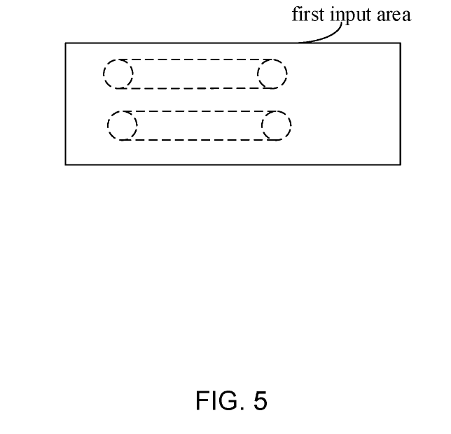

Referring now to FIG. 5, a structural schematic diagram of another touch operation detected by the touch input apparatus of the electronic device according to an embodiment is provided. In FIG. 5, the first input area may be configured to simulate the mouse movement.

As shown in FIG. 5, the touch operation comprises two touch points, each of which is for a slide touch operation. In this situation, one function corresponding to two touch points, with movement paths shown in FIG. 5 may be executed. For example, a page up function may be executed if both of the two touch points move from left to right. A page down function may be executed if both of the two touch points slide from right to left. It may be understood that the functions mentioned above are only examples. The function corresponding to parallel movement of two touch points may be another function. These functions may be predetermined or may be set up according to requirements of the user.

It may be understood that FIG. 2 to FIG. 5 are only embodiments, which are described in order for persons skilled in the art to understand the technical solution of the present invention. Other embodiments may be available based on the embodiments mentioned above.

For example, FIG. 5 is a structural schematic diagram showing only two touch points, moving horizontally. It may be understood that other movement paths, such as upward movement, downward movement etc., may be available for two touch points. For the same number of touch points, different movement paths may correspond to different functions. Additionally, the touch input may include two or more touch points. For example, it may involve the horizontal movement, vertical movement etc. for three touch points. For different number of touch points, different movement paths may correspond to different functions and will not be described further herein. Furthermore, both of the first touch operation and the second touch operation may be single click operations. In this situation, the executing a third function may be a predetermined function, such as copy etc.

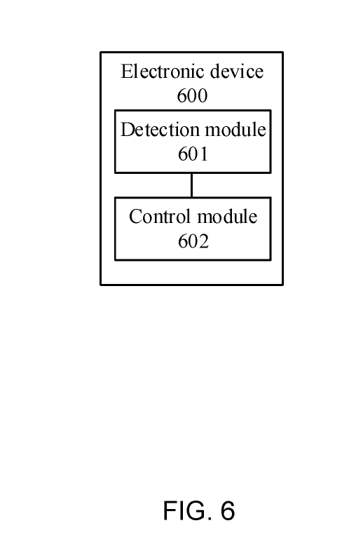

Referring now to FIG. 6, a structural schematic block diagram of an electronic device according to an embodiment is provided. The electronic device has a touch input apparatus comprising a first input area and a second input area. The electronic device as shown in FIG. 6 comprises a detection module 601 and a control module 602.

The detection module 601 is configured to detect a first touch operation in the first input area and a second touch operation in the second input area, wherein the touch operation detected in the first input area corresponds to a first function, the touch operation detected in the second input area corresponds to a second function, and the first function being different from the second function. The control module 602 is configured to execute a third function, wherein the third function combines the first function and the second function.

Respective functions in different input areas may be combined to implement other functions when the touch input apparatus of the electronic device 600 shown in FIG. 6 separately detects touch operations in different input areas.

Optionally, in some embodiments, the detection module 601 is configured specifically to simultaneously detect the first touch operation in the first input area and the second touch operation in the second input area. Optionally, in some other embodiments, the detection module 601 is configured specifically to continuously detect a first touch operation in the first input area and a second touch operation in the second input area, wherein the first touch operation and the second touch operation are continuous slide touch operations on paths. Optionally, in some embodiments, the detection module 601 is configured specifically to detect the first slide touch operation passing through the first input area and the second input area.

Optionally, in some embodiments, the control module 602 is configured specifically to execute a function corresponding to an area where a start position or an end position of the first slide touch operation is located. Optionally, in some embodiments, the control module 602 is further configured to prohibit execution of a function corresponding to an area where a non-start position or a non-end position through which the first slide touch operation passes is located. Optionally, in some embodiments, the first touch operation is a second slide touch operation, the first function is moving a cursor, the second function is simulating trigger of a left mouse button, and the control module 602 is configured specifically to execute the following function: performing an information selection according to a cursor movement path.

Optionally, in some embodiments, the first function is moving a cursor and the second function is simulating trigger of a mouse function button, wherein the mouse function button is a left or right mouse button. The control module 602 is configured specifically to execute the following function: moving the cursor when detecting a slide of the first slide touch operation in the first input area and stopping movement of the cursor when detecting a movement of the first slide touch operation to the second input area.

Optionally, in some embodiments, the first input area may be configured to simulate a mouse movement and the second area may be configured to simulate a mouse function button. Alternatively, the first area is configured to simulate the mouse function button and the second area is configured to simulate the mouse movement, wherein the mouse function button is a left mouse button or a right mouse button.

Optionally, in some embodiments, the detection module 601 is further configured to detect a touch operation having multiple touch points in the first input area. The control module 602 is further configured to execute a corresponding function according to the number and movement paths of the multiple touch points.

Optionally, in some embodiments, the touch input apparatus supports multi-touch input.

For specific functions and effects of the detection module 601 and the control module 602 in the electronic device 600 shown in FIG. 6, the method illustrated in FIG. 1, or the embodiments illustrated in FIGS. 2 to 5, may be referenced without repeated description herein.

### Touch Component and Electronic Device

In practical application, the touch pad is capable of simulating the functions that are implemented by the physical mouse, for example, simulating movements of the mouse, the right-click of the mouse, the left-click of the mouse and the like by means of user's touch operations. However, the inventors have found through study that when the user performs touch operations on the touch pad, their attention is placed mainly on the screen of the electronic device, and that the user's eyes would not always focus on the position of their finger on the touch pad. Since the conventional touch pad generally implements function difference in terms of software, the user may determine whether a touch operation is an operation on an expected area of the touch pad only after the electronic device makes a response to the touch operation; therefore, resulting in poor user experience. However, with respect to the touch pad for which function difference may be implemented in terms of hardware, the touch pad is formed by a touch panel and touch keys. The touch keys are only capable of performing singular key press operations, and the singular key press operations simulate only one function of the mouse, causing great limitation.

### Configuration 1

Configuration 1 discloses a touch component, which is any component which may perceive touch operations, such as, a touch panel, a touch screen, or the like. Specifically, the touch component of the underlying application is divided into at least two touch areas, wherein the two touch areas are distinctively physically treated such that a user perceives the difference of the two touch areas. For example, FIG. 1 illustrates a specific division mode. A touch component 100 is divided into two touch areas, including a touch area 100 and a touch area 120, wherein the touch area 100 and the touch area 120 are distinctively physically treated such that a user perceives the difference of the two touch areas.

It should be noted that the touch areas have a multi-point touch function, and the touch areas divided on the touch component may be used to achieve different functions of an electronic device. In terms of the touch component simulating a mouse, the touch areas divided on the touch component may correspond to various functions of the mouse. For example, the touch component is divided into two touch areas, wherein one touch area is a mouse movement area, and the other touch areas are a mouse left-click area and a mouse right-click area. For example, the touch component is divided into three touch areas, wherein a first touch area is a mouse movement area, a second touch area is a mouse left-click area, and a third touch area is a mouse right-click area. Nevertheless, the division of the touch areas may be implemented based on other functions of the mouse, for example, a movement function of the mouse may be further divided. Besides simulating various functions of the mouse, the touch component may be further configured to simulate other functions of the electronic device that are not described herein.

It should be emphasized herein that the two touch areas may refer to any two touch areas of the touch component. Nevertheless, to enable a user to instantly perceive the difference when the user slides from any one touch area to an adjacent touch area, as an optional mode, the two touch areas are distinctively physically treated such that the user perceives the difference of the two touch areas. Specifically, each touch area and an adjacent touch area thereof are distinctively physically treated such that the user perceives the difference of the two touch areas. To be specific, the above two touch areas may refer to any one touch area and adjacent touch areas thereof.

In an embodiment, two touch areas are distinctively physically treated in many different manners. Different manners of physical treatment correspond to different perceptions and differences of the user. For example, perception and difference by the user may comprise visual perception and difference, audile perception and difference, touch-based perception and difference and the like. Distinctive physical treatments of the two touch areas corresponding to the visual perception and difference may refer to different treatments in which the surfaces of the two touch areas can be visually differentiated, for example, by using different colors. Distinctive physical treatments of the two touch areas corresponding to the audible perception and difference may refer to different audio outputs triggered by the touch operations performed on the two touch areas, for example, different manners of touch alarm. However, how to distinctively physically treat the two touch areas corresponding to the touch-based perception and difference is hereinafter described in detail.

The touch operations on different touch areas on the touch component correspond to executions of different control instructions. It should be noted that there is at least one control instruction corresponding to the touch operations on each touch area, and those functions that may be implemented by the control instruction can be set according to the desired simulated scenario, but are not elaborated upon herein.

Optionally, the executed different control instructions corresponding to the touch operations on different touch areas on the touch component are configured to simulate different functions of a physical mouse. In this implementation manner, assuming that one touch area of the touch component is a mouse movement area, then by means of upward and downward movement operations on the touch area, the upward and downward movement function of the mouse may be simulated, and by means of leftward and rightward movement operations on the touch area, the leftward and rightward movement function of the mouse may be simulated. Assuming that another touch area of the touch component is a mouse left-click area, then by means of the click operation on the touch area, the left-click function of the mouse may be simulated. Further assuming that still another touch area of the touch component is a mouse right-click area, then by means of the click operation on the touch area, the right-click function of the mouse may be simulated.

It should be noted that different touch areas may simulate the functions of the physical mouse through cooperative touch operations. For example, the cooperative operations of the left-click area and the mouse movement area may simulate the functions of the physical mouse dragging an icon.

The at least two touch areas divided from a touch component may be in an integral structure. Specifically, all touch areas on the touch component form an indivisible entirety.

Accordingly, in an embodiment, a touch component is divided into at least two touch areas, the two touch areas being distinctively physically treated such that a user perceives the difference of the two touch areas. Therefore, when performing touch operations on the touch component, a user may determine whether the touch operations are operations occurred on an expected area of the touch component based on his/her touch, which improves the user's experience; in addition, the touch operations on different touch areas on the touch component correspond to executions of different control instructions. Therefore, multiple functions of a mouse may be simulated, and limitations of using the touch component are reduced.

In an embodiment, distinctively physically treating the at least two touch areas such that the user perceives the difference of the two touch areas includes perceiving the difference of the two touch areas via touch. However, in such a difference, there is at least one manner of physical treatment available for difference of two touch areas. To be specific, the manners of treatment are respectively described in detail with reference to Configurations 2 and 3.

### Configuration 2

Configuration 2 discloses a touch component, and the touch component is divided into at least two touch areas, the two touch areas being distinctively physically treated such that a user perceives the difference of the two touch areas. Specifically, the distinctively physically treating the at least two touch areas comprises subjecting each touch area and an adjacent touch area thereof to different surface treatment processes.

In an embodiment, there are multiple modes of surface treatment. FIG. 2 illustrates a structure of the touch component, wherein a touch component 200 is divided into three touch areas: a touch area 210, a touch area 220, and a touch area 230. The touch area 220 is respectively adjacent to the touch area 210 and the touch area 230. The touch area 220 and the touch area 210 are subjected to different surface treatment processes, and the touch area 220 and the touch area 230 are subjected to different surface treatment processes. It should be noted that since the touch area 210 is not adjacent to the touch area 230, theses two touch areas may be subjected to different surface treatment processes, or the same surface treatment process. For example, the surfaces of the touch area 210 and the touch area 230 are subjected to matte process treatments, and are matte surfaces, whereas the surface of the touch area 220 is subjected to a non-matte process, and is a smooth surface. In another example, the touch area 210 is matte surface, the touch area 220 is smooth surface, and the touch area 230 is a surface having a plurality of small convexities.

The touch operations on different touch areas on the touch component correspond to executions of different control instructions.

In an embodiment, a touch component is divided into at least two touch areas. Specifically, each touch area and an adjacent touch area thereof are subjected to different surface treatment processes, such that a user performs touch operations on the touch component, and when sliding from one touch area to another touch area, a user may determine whether the touch operations are operations occurred on an expected area of the touch component based on touch on the surface of the touch area, which improves the user's experience. In addition, the touch operations on different touch areas on the touch component correspond to executions of different control instructions. Therefore, a multiple of functions of a mouse may be simulated, and limitations of using the touch component are reduced.

### Configuration 3

Configuration 3 discloses a touch component which is divided into at least two touch areas, the two touch areas being distinctively physically treated such that a user perceives the difference of the two touch areas. Specifically, the distinctively physically treating the at least two touch areas comprises: a physical boundary area is arranged between each of the touch areas and the adjacent touch areas thereof.

The physical boundary area may divide into two touch areas in a plurality of manners. FIG. 3 illustrates a structure of the touch component, wherein a touch component 300 is divided into four touch areas: a touch area 310, a touch area 320, a touch area 330, and a touch area 340. A physical boundary area 300A is arranged between the touch area 310 and the touch area 320, a physical boundary area 300B is arranged between the touch area 320 and the touch area 330, and a physical boundary area 300C is arranged between the touch area 330 and the touch area 340. It should be noted that the physical boundary area is a boundary between two adjacent touch areas, and achieves a function that a user perceives the difference of the two adjacent touch areas. An area of the physical boundary area may be defined according to actual circumstances, but will not be elaborated upon herein.

As another implementation manner of dividing the two touch area by means of the physical boundary area, the physical boundary area is subjected to surface treatment using a first process and the two touch areas divided by the physical boundary area are subjected to surface treatment by using a second process.

In an embodiment, the first process is different from the second process. For example, the first process is an etching process, and the second process is a non-etching process. In this case, the surface of the physical boundary area of the touch area is treated by using an etching mode. As a specific implementation mode of the etching process, the surface of the physical boundary area of the touch area may be treated by using a chemical reaction or physical impact mode, such that a user is capable of perceiving the difference of this area against other touch areas. The second process used by the two touch areas divided by the physical boundary area is not specifically defined, as long as the second process used by the two touch areas distinguishes from the etching process. Nevertheless, the embodiment are not limited to this one implementation mode. For example, the surface of the physical boundary area employs a frosted surface after the frosting process treatment, and the surface of the touch area employs a non-frosted surface without the frosting process treatment, for example, a smooth surface after the smoothing process treatment.

As another implementation manner of dividing the two touch area by means of the physical boundary area, the physical boundary area is a concave or a convex area relative to the adjacent touch area. Specifically, when each area is compared based on the same horizontal datum line of the touch component, a height of the physical boundary area is lower or higher than other touch areas. It should be noted that to enable a user to slide from one touch area to another touch area via the physical boundary area without too much obstacles, a concave or a convex degree of the physical boundary area should not be too large. For example, the physical boundary area may have a concave or convex length of 2 mm relative to the touch area.

Using the physical boundary area, a user can perceive the slide from one touch area to another touch area via the physical boundary area. The touch operations on different touch areas on the touch component correspond to executions of different control instructions.

In this embodiment, a touch component is divided into at least two touch areas. Specifically, a physical boundary area is arranged between each touch area and the adjacent touch area thereof. The physical boundary area is subjected to surface treatment using a first process and the at least two touch areas divided by the physical boundary area are subjected to surface treatment by using a second process such that a user performs touch operations on the touch component and when sliding from one touch area to another touch area via the physical boundary area the user may determine whether the touch operations are operations occurred on an expected area of the touch component based on differences of touch on the surface of the physical boundary area relative to touch on the surface of the touch area, which improves the user's experience. In addition, the touch operations on different touch areas on the touch component correspond to executions of different control instructions. Therefore, multiple functions of a mouse may be simulated, and limitations of using the touch component are reduced.

A touch component is disclosed in another embodiment and the touch component is divided into at least two touch areas, the two touch areas being distinctively physically treated such that a user perceives the difference of the two touch areas. In this embodiment, the executed different control instructions corresponding to the touch operations on different touch areas on the touch component are configured to simulate different functions of a physical mouse.

As an implementation mode, the touch component is divided into at least three areas, comprising: a first area, a second area, and a third area. Specifically, a first operation on the first area is configured to simulate a first function of a physical mouse, a second operation on the second area is configured to simulate a second function of the physical mouse, and a third operation on the third area is configured to simulate a third function of the physical mouse. The first function, the second function and the third function are different from one another and respectively at least include at least one function of the physical mouse.

As an implementation mode, the first function is a left-click function, the second function is a cursor movement function, and the third function is a right-click function. Corresponding to this function, as an optional area distribution mode, and for ease of user's operation, the second area is located between the first area and the third area, the first area is adjacent to the second area, and is located on the left of the second area, and the third area is adjacent to the second area, and is located on the right of the second area. Nevertheless, since different users have different operation habits, other location relationships may be set. For example, the second area is located between the first area and the third area, the first area is adjacent to the second area, and is located on the right of the second area, and the third area is adjacent to the second area, and is located on the left of the second area, but will not be defined in the present invention.

An embodiment further discloses an electronic device, and the electronic device includes the touch component as described in any embodiment above. The electronic device may further include a first component set on the same panel with the touch component, and the first component may be a keyboard component, or may be an electromagnetic screen component. It should be noted that the electronic device in the embodiments may be a device such as a mobile phone, a laptop computer, a tablet computer, or the like.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
detecting, at an information handling device, a first touch operation in a first input area and a second touch operation in a second input area, wherein the first touch operation detected in the first input area corresponds to a first function and the touch operation in the second input area corresponds to a second function, the first function being different from the second function; and
executing, using a processor, a third function, wherein the third function combines the first function and the second function.

2. The method of claim 1, wherein the detecting comprises simultaneously detecting the first touch operation in the first input area and the second touch operation in the second input area.

3. The method of claim 1, wherein the first input area is configured to simulate a mouse movement and the second input area is configured to simulate a mouse function button.

4. The method of claim 1, wherein at least one of the first touch operation and the second touch operation comprise multiple touch points and wherein the executing the third function comprises executing based upon at least one of the multiple touch points and movement paths associated with the multiple touch points.

5. The method of claim 1, wherein the detecting comprises continuously detecting the first touch operation in the first input area and the second touch operation in the second input area, wherein the first touch operation and the second touch operation comprise continuous slide touch operations on paths.

6. The method of claim 5, further comprising detecting a first slide touch operation passing through the first input area and the second input area.

7. The method of claim 6, wherein the executing the third function comprises executing a function corresponding to an area where a start position or an end position of the first slide touch operation is located.

8. The method of claim 7, wherein the executing the third function comprises prohibiting execution of a function corresponding to an area where a non-start position or a non-end position through which the first slide touch operation passes is located.

9. The method of claim 8, wherein the first function is associated with a cursor movement, the second function is associated with a mouse function button, and the executing the third function comprises moving the cursor responsive to detecting a slide of the first slide touch operation in the first input area and halting the cursor responsive to detecting a slide of the first slide touch operation in the second input area.

10. The method of claim 9, wherein the mouse function button comprises at least one of a left mouse button or a right mouse button.

11. A method, comprising:
receiving, at a touch component, a touch operation, wherein the touch component comprises at least two touch areas and wherein each touch area of the at least two touch areas is physically distinct from other touch areas of the at least two touch areas; and
executing, using a processor, a control instruction associated with the touch operation, wherein the control instruction is dependent on the touch area the touch operation is provided to.

12. The method of claim 11, wherein the at least two touch areas are positioned substantially adjacent to each other on the touch component.

13. The method of claim 11, further comprising at least one physical boundary that divides each touch area of the at least two touch areas from the other touch areas of the at least two touch areas.

14. The method of claim 13, wherein the at least one physical boundary is subjected to surface treatment using a first process.

15. The method of claim 13, wherein the at least one physical boundary comprises a concave boundary.

16. The method of claim 13, wherein the at least one physical boundary comprises a convex boundary.

17. The method of claim 11, wherein the at least two touch areas comprise a first area, a second area, and a third area; and
wherein a first touch operation on the first area is configured to simulate a first function of a physical mouse, a second operation on the second area is configured to simulate a second function of the physical mouse, and a third operation on the third area is configured to simulate a third function of the physical mouse; and the first function, the second function and the third function are different from one another.

18. The method of claim 11, wherein the first function is associated with a left-click function, the second function is associated with a cursor movement function, and the third function is associated with a right-click function.

19. The method of claim 11, wherein each of the at least two touch areas undergoes a different surface treatment process so as to make each surface of the at least two touch areas physically noticeable to a user.

20. An electronic device, comprising:
a touch component integral to the electronic device, wherein the touch component comprises at least two touch areas;
wherein each touch area of the at least two touch areas is physically distinct from other touch areas of the at least two touch areas; and
wherein each touch area of the at least two touch areas is associated with a control instruction, wherein the control instruction is different for each touch area of the at least two touch areas.
